(19) United States
(12) Patent Application Publication
(10) Pub. No.: US 2021/0170277 A1
(43) Pub. Date: Jun. 10, 2021

(54) NON-TRANSITORY COMPUTER-READABLE MEDIUM AND VIDEO GAME PROCESSING SYSTEM

(71) Applicant: SQUARE ENIX CO., LTD., Tokyo (JP)

(72) Inventors: Takamasa SHIBA, Tokyo (JP); Hiroshi KOBAYASHI, Tokyo (JP); Jun WAGA, Tokyo (JP)

(73) Assignee: SQUARE ENIX CO., LTD., Tokyo (JP)

(21) Appl. No.: 17/115,092

(22) Filed: Dec. 8, 2020

(30) Foreign Application Priority Data
Dec. 10, 2019 (JP) 2019-222895

(51) Int. Cl. A63F 13/5378; G06F 3/14; A63F 13/216

(52) U.S. Cl. CPC A63F 13/5378; A63F 13/216; G06F 3/1454

(57) ABSTRACT

A non-transitory computer-readable medium including a video game processing program for causing a server to perform functions to control progress of a video game using positional information of a user terminal in response to an operation of a user is provided. The functions include: a specifying function configure to specify a user corresponding position in a virtual space corresponding to map information of a real space; a setting function configured to set a different position from the user corresponding position in the virtual space; and a displaying function configured to display a user related object in the virtual space. The displaying function includes: a function configured to display the user related object at the user corresponding position for the user; and a function configured to display a predetermined object at a set position set by the setting function for the other users.

### CROSS-REFERENCE TO RELATED APPLICATION

The present application claims priority to Japanese Patent Application No. 2019-222895 filed on Dec. 10, 2019, the disclosure of which is expressly incorporated herein by reference in its entirety for any purpose.

### BACKGROUND

### 1. Field

At least one of embodiments of the present invention relates to a non-transitory computer-readable medium including a video game processing program and a video game processing system for causing a server to perform functions to control progress of a video game using positional information of a user terminal in response to an operation of a user.

### 2. Description of the Related Art

In recent years, various systems each using positional information of a user terminal have been proposed in a field of video games.

In such a system, there is a system in which a user terminal displays a virtual space corresponding to map information of a real space and further displays various kinds of objects in the virtual space on the basis of positional information of the user terminal. See WO2017/090273, for example.

### SUMMARY

However, in the conventional system, in a case where the positional information of the user terminal is used while associating the real space with the virtual space, there is a possibility that personal information such as a user's own position or a home position of a user may not be protected.

It is an object of at least one of embodiments of the present invention to solve the problem described above, and to allow a user to play a video game with security.

According to one non-limiting aspect of the present invention, there is provided a non-transitory computer-readable medium including a video game processing program for causing a server to perform functions to control progress of a video game using positional information of a user terminal in response to an operation of a user.

The functions include a specifying function configure to specify a position of the user (hereinafter, referred to as a “user corresponding position”) in a virtual space corresponding to map information of a real space.

The functions also include a setting function configured to set a different position from the user corresponding position in the virtual space.

The functions also include a displaying function configured to display an object related to the user (hereinafter, referred to as a “user related object”) in the virtual space. In this case, the displaying function includes: a function configured to display the user related object at the user corresponding position for the user, and a function configured to display a predetermined object at a position set by the setting function (hereinafter, referred to as a “set position”) for the other users.

According to another non-limiting aspect of the present invention, there is provided a video game processing system for controlling progress of a video game using positional information of a user terminal in response to an operation of a user. The video game processing system includes a communication network, a server, and a user terminal.

The video game processing system includes a specifying unit configured to specify a position of the user (hereinafter, referred to as a “user corresponding position”) in a virtual space corresponding to map information of a real space.

The video game processing system also includes a setting unit configured to set a different position from the user corresponding position in the virtual space. The video game processing system also includes a displaying unit configured to display an object related to the user (hereinafter, referred to as a “user related object”) in the virtual space.

In this case, the displaying unit is configured to: display the user related object at the user corresponding position for the user; and display a predetermined object at a position set by the setting unit (hereinafter, referred to as a “set position”) for the other users.

According to still another non-limiting aspect of the present invention, there is provided a non-transitory computer-readable medium including a video game processing program for causing a user terminal to perform terminal functions.

The terminal functions include a function configured to receive, from a server, information regarding server functions included in the server.

The terminal functions also includes function configured to execute an input or an output corresponding to each of the server functions.

In this case, the server performs the server functions to control progress of a video game using positional information of the user terminal in response to an operation of a user.

The server functions include a specifying function configure to specify a position of the user (hereinafter, referred to as a “user corresponding position”) in a virtual space corresponding to map information of a real space.

The server functions also include a setting function configured to set a different position from the user corresponding position in the virtual space.

The server functions also include a displaying function configured to display an object related to the user (hereinafter, referred to as a “user related object”) in the virtual space.

In this case, the displaying function includes: a function configured to display the user related object at the user corresponding position for the user; and a function configured to display a predetermined object at a position set by the setting function (hereinafter, referred to as a “set position”) for the other users.

According to each of the embodiments of the present application, one or two or more shortages are solved.

### BRIEF DESCRIPTION OF DRAWINGS

The foregoing and other objects, features and advantages of the present disclosure will become more readily apparent from the following detailed description of preferred embodiments of the present disclosure that proceeds with reference to the appending drawings:

FIG. 1 is a block diagram illustrating an example of a configuration of a video game processing system corresponding to at least one of the embodiments of the present disclosure;

FIG. 2 is a block diagram illustrating a configuration of a server corresponding to at least one of the embodiments of the present disclosure;

FIG. 3 is a flowchart illustrating an example of game processing corresponding to at least one of the embodiments of the present disclosure;

FIG. 4 is a flowchart illustrating an example of an operation of a server side in the game processing corresponding to at least one of the embodiments of the present disclosure;

FIG. 5 is a flowchart illustrating an example of an operation of a terminal side in the game processing corresponding to at least one of the embodiments of the present disclosure;

FIG. 6 is a block diagram illustrating a configuration of a server corresponding to at least one of the embodiments of the present disclosure;

FIG. 7 is a flowchart illustrating an example of game processing corresponding to at least one of the embodiments of the present disclosure;

FIG. 8 is a block diagram illustrating a configuration of a server corresponding to at least one of the embodiments of the present disclosure;

FIG. 9 is a flowchart illustrating an example of game processing corresponding to at least one of the embodiments of the present disclosure;

FIG. 10 is a block diagram illustrating a configuration of a server corresponding to at least one of the embodiments of the present disclosure;

FIG. 11 is a flowchart illustrating an example of game processing corresponding to at least one of the embodiments of the present disclosure;

FIG. 12 is a block diagram illustrating a configuration of a server corresponding to at least one of the embodiments of the present disclosure;

FIG. 13 is a flowchart illustrating an example of game processing corresponding to at least one of the embodiments of the present disclosure;

FIG. 14 is a block diagram illustrating a configuration of a server corresponding to at least one of the embodiments of the present disclosure;

FIG. 15 is a flowchart illustrating an example of game processing corresponding to at least one of the embodiments of the present disclosure;

FIG. 16 is a block diagram illustrating a configuration of a server corresponding to at least one of the embodiments of the present disclosure;

FIG. 17 is a flowchart illustrating an example of game processing corresponding to at least one of the embodiments of the present disclosure; and

FIGS. 18A and 18B are explanatory drawings illustrating examples of display screens corresponding to at least one of the embodiments of the present disclosure.

### DETAILED DESCRIPTION

Hereinafter, examples of embodiments according to the present disclosure will be described with reference to the drawings. Note that, various components in the respective embodiments described below can be appropriately combined without any contradiction or the like. In addition, the description of the content described as a certain embodiment may be omitted in another embodiment Further, the content of an operation or processing that docs not relate to features of each of the embodiments may be omitted. Moreover, the order of various processes that constitute various flows described below may be changed without any contradiction or the like of processing content.

### First Embodiment

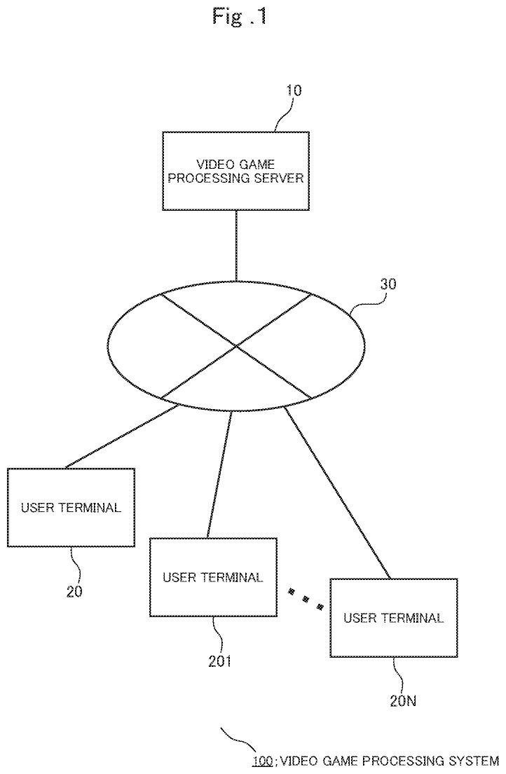

FIG. 1 is a block diagram illustrating an example of a configuration of a video game processing system 100 according to one embodiment of the present disclosure. As illustrated in FIG. 1, the video game processing system 100 includes a video game processing server 10 (hereinafter, referred to as a “server 10”) and user terminals 20, and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not illustrated in the drawings, the plurality of user terminals 20 and 201 to 20N is connected to the communication network 30 by executing data communication with base stations managed by a telecommunication carrier by means of a radio communication line.

The video game processing system 100 includes the server 10 and the plurality of user terminals 20 and 201 to 20N, whereby various kinds of functions for executing various kinds of processing in response to an operation of the user are performed.

The server 10 is managed by an administrator of the video game processing system 100, and has various kinds of functions to provide information regarding various kinds of processing to the plurality of user terminals 20 and 201 to 20N, In the present embodiment, the server 10 is constructed by an information processing apparatus, such as a WWW server, and includes a storage medium for storing various kinds of information. In this regard, the server 10 is provided with a general configuration for executing the various kinds of processing as a computer, such as a control section and a communicating section. However, its explanation herein is omitted. Further, in the video game processing system 100, it is preferable that the server 10 manages various kinds of information from a point of view to reduce a processing load on each of the plurality of user terminals 20 and 201 to 20N. However, a storing section for storing various kinds of information may include a storage region in a state that the server 10C an access the storage region. For example, the server 10 may be configured so as to be provided with a dedicated storage region outside the server 10.

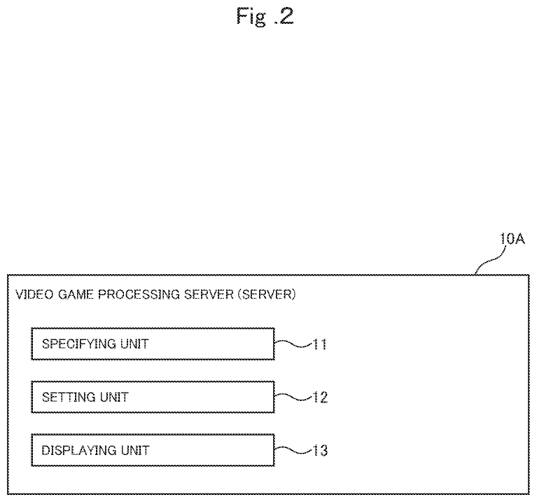

FIG. 2 is a block diagram illustrating a configuration of a video game processing server 10A (hereinafter, referred to as a “server 10A”), which is an example of the server 10. As illustrated in FIG. 2, the server 10A at least includes a specifying unit 11, a setting unit 12, and a displaying unit 13.

The specifying unit 11 has a function to specify a position of the user (that is, a user corresponding position) in a virtual space corresponding to map information of a real space.

Here, the virtual space corresponding to the map information of the real space means a virtual space that is generated by using the map information of the real space. A configuration to generate the virtual space is not limited particularly. However, it is preferable that the specifying unit 11 is configured so that the user can recognize that the virtual space is generated on the basis of the map information of the real space. As an example of such a configuration, there is a configuration in which a virtual space is generated by respectively arranging objects corresponding to roads and buildings of a real space at positions corresponding to the real space.

Further, a configuration to specify a position corresponding to the user is not limited particularly. However, it is preferable that the specifying unit 11 is configured so that the user can recognize so as to correspond to the user himself or herself. As an example of such a configuration, there is a configuration in which a position in a virtual space corresponding to positional information of the user terminal 20 of the user is specified.

Further, the positional information of the user terminal 20 means information indicating a position in the real space. A configuration of the positional information is not limited particularly. However, it is preferable that the specifying unit 11 is configured so as to include a coordinate by which the position of the user terminal 20 in the real space can be specified. As examples of the configuration to obtain the positional information of tire user terminal 20, there are a configuration to obtain the positional information by using a GPS signal, and a configuration to obtain the positional information on the basis of reception intensity information of wireless signals from a plurality of beacon transmitters.

The setting unit 12 has a function to set a different position from the user corresponding position in the virtual space.

Here, the phrase “set a different position from the user corresponding position (hereinafter, referral to as a “set position”) means to set, as the set position, a coordinate different from a coordinate of the user corresponding position in tire virtual space. A configuration to set the different position from the user corresponding position is not limited particularly. However, it is preferable that the setting unit 12 is configured to set a position of the set position so that the set position and the user corresponding position are separated from each other by a distance defined in advance or longer, or to set the position of the set position within an area different from another area where the user corresponding position exists. As examples of the area used for setting the position of the set position, there are areas divided by administrative divisions, areas divided substantially evenly by each predetermined area, and areas for which an area is defined in accordance with the number of users in each predetermined area.

The displaying unit 13 has a function to display an object related to tire user (hereinafter, referred to as a “user related object”) in the virtual space.

Here, the user related object means an object that the user or the other users can recognize to be related to the user. The user related object is not limited particularly. However, it is preferable that the displaying unit 13 is configured so that the user related object is an object regarding personal information of the user. As an example of the personal information of the user, there is a place in the real space, which is connected to a life of the user and which the user does not want for the other users to know, (that is, a user secret place). As examples of the user secret place, there are a user's home, a parent's or child's home of the user, a work place, an acquaintance's home, a user's school, stores where the user is a regular customer, and the nearest station from the user's home. As examples of the object that the user can recognize to be related to the personal information of the user, there are an object with appearance including information related to the user and a user character of the user.

Further, the displaying unit 13 also has a function to display the user related object at the user corresponding position for the user, and a function to display a predetermined object at the position set by the setting unit 12 (that is, the set position) for the other users.

Here, a configuration to display the user related object at the user corresponding position is not limited particularly. However, it is preferable that the displaying unit 13 is configured so that the user can recognize that the user related object exists at the user corresponding position in the virtual space. As an example of such a configuration, there is a configuration in which a user related object is displayed in a virtual space with appearance that allows the user to distinguish the user related object from the other objects.

Further, each of the other users means a user who is different from one user who uses the user terminal 20. Namely, each of the other users means a user who is different from the user himself or herself for each user. In this regard, it is preferable that each of the other users uses a user terminal 20 different from the user terminal 20 of the user.

Further, the predetermined object means an object corresponding to the user related object. As examples of the object corresponding to the user related object, there arc an object that the other user can recognize to have a relationship with a user related object or have similar functions, an object whose appearance is similar to that of the user related object, and an icon indicating the user related object.

Further, a configuration to display the predetermined object at the set position is not limited particularly. However, it is preferable that the displaying unit 13 is configured so that the user can recognize that a predetermined object exists at a set position in a virtual space. As an example of such a configuration, there is a configuration in which a user displays a predetermined object, in a virtual space with appearance that can be distinguished from a user related object and the other objects.

Further, the phrase “display a predetermined object at the set position for the other users” means that an object corresponding to the user related object is displayed at the set position in the user terminal 20 of each of the other users. Namely, since the user is another user for each of the other users, an object corresponding to an object related to each of the other users is displayed in the user terminal 20 of the user as the predetermined object by the displaying unit 13.

Each of the plurality of user terminals 20, and 201 to 20N is managed by the user, and is configured by a communication terminal capable of playing a network delivery type game, such as a cellular telephone terminal, a PDA (Personal Digital Assistants), a portable game apparatus, or a so-called wearable device, for example. In this regard, the configuration of the user terminal that the video game processing system 100 can include is not limited to the example described above. Each of the user terminals 20. and 201 to 20N may be configured so that the user can recognize the video game. As the other examples of the user terminal, there are one obtained by combining various kinds of communication terminals, a personal computer, and a stationary game apparatus.

Further, each of the plurality of user terminals 20, and 201 to 20N is connected to the communication network 30, and includes hardware (for example, a display device for displaying a browser screen or a game screen based on a coordinate and the like) and software for executing various kinds of processes by communicating with the server 10A. In this regard, each of the plurality of user terminals 20, and 201 to 20N may be configured so as to be able to directly communicate with each other without the server 10A.

Next, an operation of the video game processing system 100 thereinafter, referred to as the “system 100”) according to the present embodiment will be described.

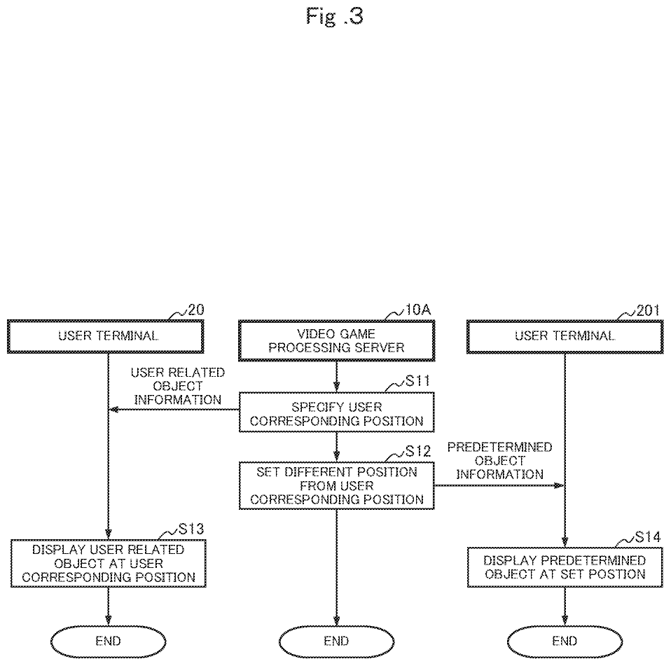

FIG. 3 is a flowchart illustrating an example of game processing executed by the system 100. In the game processing according to the present embodiment, a process related to a control of progress of the video game using the positional information of the user terminal 20 in response to an operation of the user is executed. Hereinafter, a case where the server 10A, the user terminal 20 (hereinafter, referred to as the “terminal 20”), and the user terminal 201 (hereinafter, referred to as the “terminal 201”) operated by another user different from the user who operates the terminal 20 execute the game processing will be described as an example.

The game processing is started as an opportunity that the terminal 20 accessing the server 10A receives a display request of the user related object, for example. Hereinafter, display of the user related object of the user who operates the terminal 20 will be described as an example.

In the game processing, the server 10A first specifics a user corresponding position in a virtual space that corresponds to map information of a real space (Step S11). In the present embodiment, when the user corresponding position is specified, the server 10A transmits, to the terminal 20, user related object information for displaying a user related object at the user corresponding position.

When the user corresponding position is specified, the server 10A sets a different position from the user corresponding position (Step S12). In the present embodiment, when the different position from the user corresponding position is set, the server 10A transmits, to the terminal 201, predetermined object information for displaying a predetermined object at the different position (that is, a set position) from the user corresponding position.

When the user related object information is received from the server 10A, the terminal 20 displays the user related object at the user corresponding position for the user (Step S13). In the present embodiment, the terminal 20 outputs a predetermined game screen to a display screen of a display device thereof on the basis of the user related object information from the server 10A.

When the predetermined object information is received from the server 50A, the terminal 201 displays the predetermined object at the set position set by the server 10A for the other users (Step S14). In the present embodiment, the terminal 201 outputs a predetermined game screen to a display screen of a display device thereof on the basis of the user related object information from the server 10A.

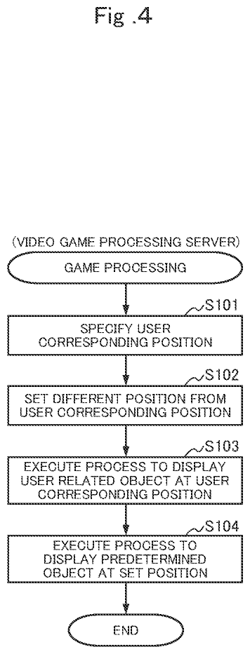

FIG. 4 is a flowchart illustrating an example of an operation of the server 10A side in the game processing. Here, an operation of the server 10A in the system 100 will be described again.

In the game processing, the server 10A first specifies a user corresponding position in a virtual space that corresponds to map information of a real space (Step S101); sets a different position from the user corresponding position (Step S102); executes a process to display a user related object at the user corresponding position for the user thereof (Step S103); and executes a process to display a predetermined object at a set position thus set for the other users (Step S104).

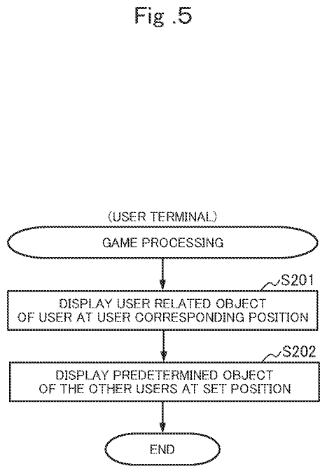

FIG. 5 is a flowchart illustrating an example of an operation of the terminal 20 side in a case where the terminal 20 executes the game processing. Hereinafter, a case where the terminal 20 executes the game processing by a single body will be described as an example. In this regard, the configuration of the terminal 20 includes the similar functions to those of the server 10A except that the terminal 20 receives various kinds of information from the server 10. For this reason, its explanation is omitted from a point of view to avoid repeated explanation.

In the game processing, when user related object information is received from the server 10A, the terminal 20 displays a user related object at a user corresponding position for the user thereof (Step S201). When predetermined object information is received from the server 10A, the terminal 20 displays a predetermined object at a set position thus set for the other users (Step S202). Further, in the present embodiment, the terminal 20 communicates with the server 10A to obtain information used for each of the steps. In this regard, the terminal 20 may be configured so as to refer to a storage unit included therein to specify the information used for each of the steps.

As explained above, as one side of the first embodiment, the server 10A for performing the functions to control progress of the video game using the positional information of the user terminal in response to the operation of the user is configured so as to include the specifying unit 11, the setting unit 12, and the displaying unit 13. Thus, the specifying unit 11 specifies the position corresponding to the user (that is, the user corresponding position) in the virtual space corresponding to the map information of the real space; the setting unit 12 sets the set position in the virtual space; the displaying unit 13 displays the user related object at the user corresponding position for the user, and displays the predetermined object at the set position for the other users. Therefore, it is possible to allow the user to play the video game with security.

Namely, the predetermined object is displayed at the set position different from the user corresponding position for the other users. For this reason, it is possible to allow the user to play the video game with security compared with a case where the user related object is displayed at the user corresponding position. In other words, the video game processing system 100 is configured so that such a position that is within a movement range of the user in the real space is not discloses to the other users as it is, but a different position from the position is disclosed to the other users in the video game, the user no longer worries about invasion of privacy by making the user's living area known by strangers via the video game. Therefore, it becomes possible for the user to use the positional information in the video game with security.

Further, by setting the set position corresponding to the user corresponding position of each of a plurality of users who participates in the video game, tire server 10A may execute a process to display the predetermined object at the set position as a position of the user when the position of each of the users is displayed as a function of the video game for the other users. Namely, in a case where a user corresponding position of a user different from the user who operates the user terminal 20 is included in a display area of the virtual space in the user terminal 20, it becomes possible to reduce a processing load required to cause the user to recognize the position of each of the other users compared with a method of setting a position different from the user corresponding position and displaying a predetermined object each time.

### Second Embodiment

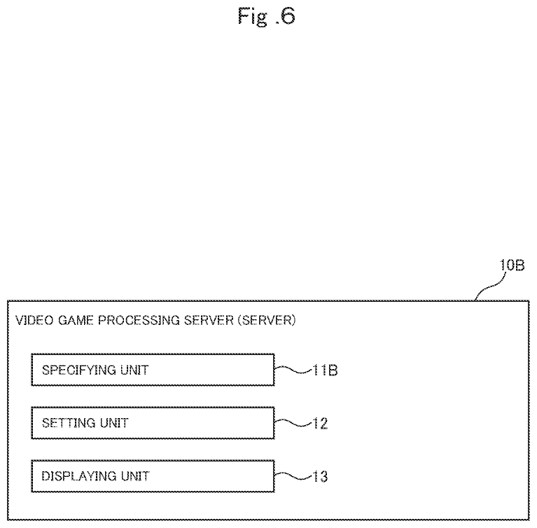

FIG. 6 is a block diagram illustrating a configuration of a video game processing server 10B (hereinafter, referred to as a “server 10B”), which is an example of the video game processing server 10 (sec FIG. 1). In the present embodiment, the server 10B at least includes a specifying unit 11B, a setting unit 12, and a displaying unit 13.

The specifying unit 11B has a function to specify a position designated by a user in a virtual space as a user corresponding position.

Here, the position designated by the user in the virtual space means a position defined in accordance with an intention of the user. A configuration to cause the user to designate a position in the virtual space is not limited particularly. The specifying unit 11B may be configured so as to cause the user to designate an arbitrary position from the whole virtual space; may be configured so as to cause the user to designate an arbitrary position within a predetermined area in the virtual space; or may be configured so as to cause the user to select any one from a plurality of choices. In this regard, the specifying unit 11B may be configured so that there is a plurality of designated positions or the designated position indicates an area.

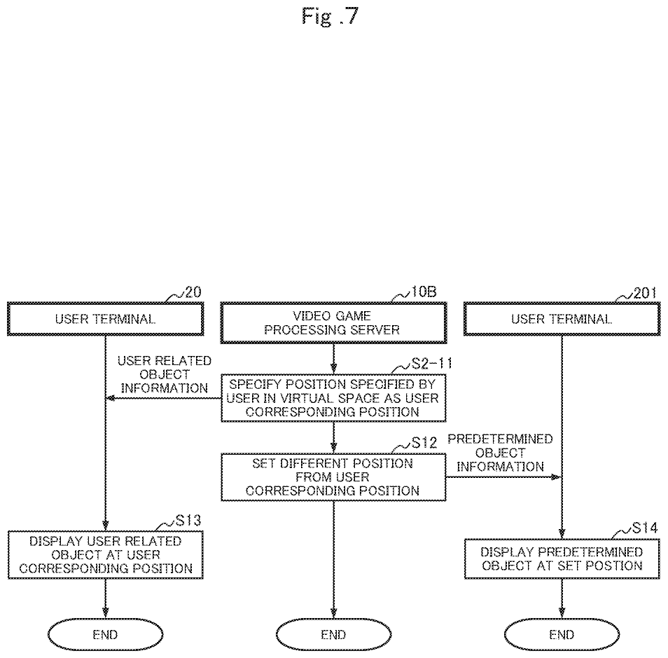

FIG. 7 is a flowchart illustrating an example of game processing executed by the video game processing system 100 (see FIG. 1). Hereinafter, operations of the server 10B and a user terminal 20 (hereinafter, referred to as a “terminal 20”) will be described as an example. In th is regard, a flowchart illustrating an operation of each of tire server 10B and the terminal 20 is omitted from a point of view to avoid repeated explanation.

In the game processing, the server 10B first specifies a position designated by a user in a virtual space as a user corresponding position (Step S2-11). In the present embodiment, when the position designated by the user is specified as the user corresponding position, the server 10B transmits, to the terminal 20, user related object information for displaying a user related object at the position designated by the user in the virtual space.

As explained above, as one side of the second embodiment, the server 10B is configured so as to include the specifying unit 11B, the setting unit 12, and the displaying unit 13. Thus, the specifying unit 11B specifies the position designated by the user in the virtual space as the user corresponding position; and the displaying unit 13 displays the user related object at a position desired by the user, and displays a predetermined object at a set position for the other users. Therefore, it becomes possible to cause the position of the user to influence arrangement of the user related object. This makes it possible to improve interest of the user in the video game.

### Third Embodiment

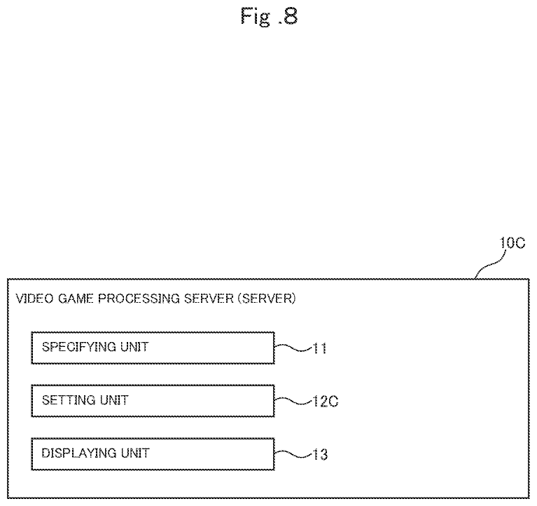

FIG. 8 is a block diagram illustrating a configuration of a video game processing server 10C (hereinafter, referred to as a “server 10C”), which is an example of the video game processing server 10 (see FIG. 1). In the present embodiment, the server 10C at least includes a specifying unit 11, a setting unit 12C, and a displaying unit 13.

The setting unit 12C has a function to set, as a set position, a position separated from a user corresponding position by a first distance or longer and a second distance or shorter. The first distance is longer than the first distance.

Here, the first distance is not limited particularly. However, it is preferable that the setting unit 12C is configured so that it may be difficult for another user to guess the user corresponding position on the basis of the position separated from the user corresponding position by the first distance or longer. As examples of the position separated from the user corresponding position by the first distance or longer, there are a position separated from the user corresponding position in a predetermined direction by the first distance or longer, a position outside the same site, outside the same town, or outside a living area of the user, and a position that satisfies a predetermined condition (for example, an adjacent site).

Further, the second distance is not limited particularly. However, it is preferable that the setting unit 12C is configured so that the position separated from the user corresponding position by the second distance or shorter may be related to the user corresponding position. As an example of the position separated from the user corresponding position by the second distance or shorter, there is a position within the same or adjacent area as the user corresponding position.

Further, the position set by the setting unit 12C as the set position is not limited particularly so long as it is a position separated from the user corresponding position by the first distance or longer and the second distance, which is longer than the first distance, or longer. As an example of the position set by the setting unit 12C as the set position, there is a configuration in which a position that satisfies a condition to be separated by the first distance or longer and the second distance or shorter and is selected at random is set as a set position.

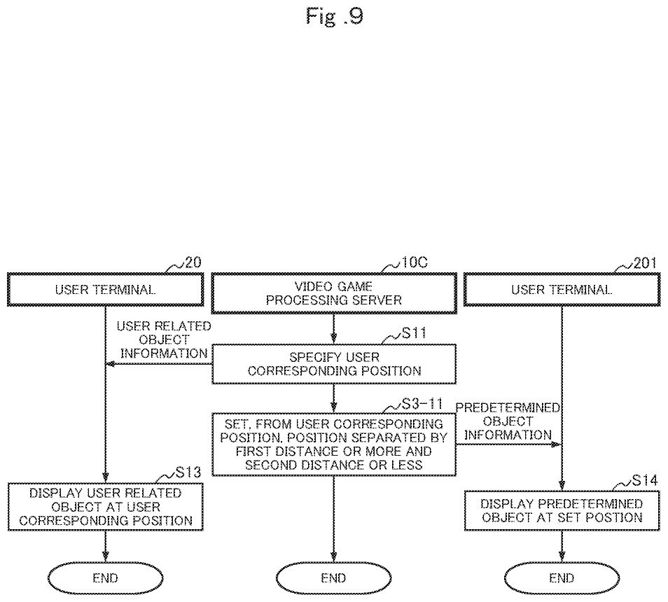

FIG. 9 is a flowchart illustrating an example of game processing executed by the video game processing system 100 (see FIG. 1). Hereinafter, operations of the server 10C and a user terminal 20 (hereinafter, referred to as a “terminal 20”) will be described as an example. In this regard, a flowchart illustrating an operation of each of the server 10C and the terminal 20 is omitted from a point of view to avoid repeated explanation.

In the game processing, when a user corresponding position is specified, the server 10C sets, as a 3ct position, a position separated by a first distance or longer and a second distance or shorter (Step S3-11). In the present embodiment, when the set position corresponding to the user corresponding position is set, the server 10C transmits, to a user terminal 201, predetermined object information for displaying a predetermined object at the set position.

As explained above, as one side of the third embodiment, the server 10C is configured so as to include the specifying unit 11, the setting unit 12C, and the displaying unit 13. Thus, the setting unit 12C sets, as the set position, the position separated from the user corresponding position by the first distance or longer and the second distance, which is longer than the first distance, or shorter. Therefore, it is possible to cause the user himself or herself to play the video game with security while disclosing the position corresponding to the user without making the user excessively aware of a privacy protecting method.

### Fourth Embodiment

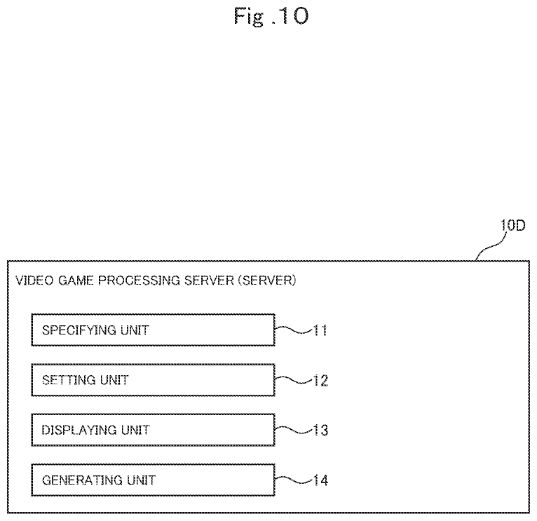

FIG. 10 is a block diagram illustrating a cot figuration of a video game processing server 10D (hereinafter, referred to as a “server 10D”), which is an example of the video game processing server 10 (see FIG. 1). In the present embodiment, the server 10D at least includes a specifying unit 11, a setting unit 12, a displaying unit 13, and a generating unit 14.

The generating unit 14 has a function to generate a first event corresponding to a user related object in accordance with a positional condition between a position in a virtual space corresponding to positional information of a user terminal 20 of a user (hereinafter, referred to as a “virtual user position”) and a user corresponding position.

Here, the positional condition regarding the virtual user position and the user corresponding position means at least one predetermined condition that includes a predetermined relationship between the virtual user position and the user corresponding position. As an example of the predetermined condition, there is a case where a predetermined operation is executed by the user terminal 20.

Further, the first event means an event that is associated with the user related object in advance. A configuration to associate the event with the user related object is not limited particularly. For example, the generating unit 14 may be configured so as to associate the event with the user related object in a case where the user related object is displayed at the user corresponding position, or may be configured so that an event is associated with the user related object by an operation from the user against the user terminal 20. As an example of the first went, there is an event regarding progress of a video game of the user.

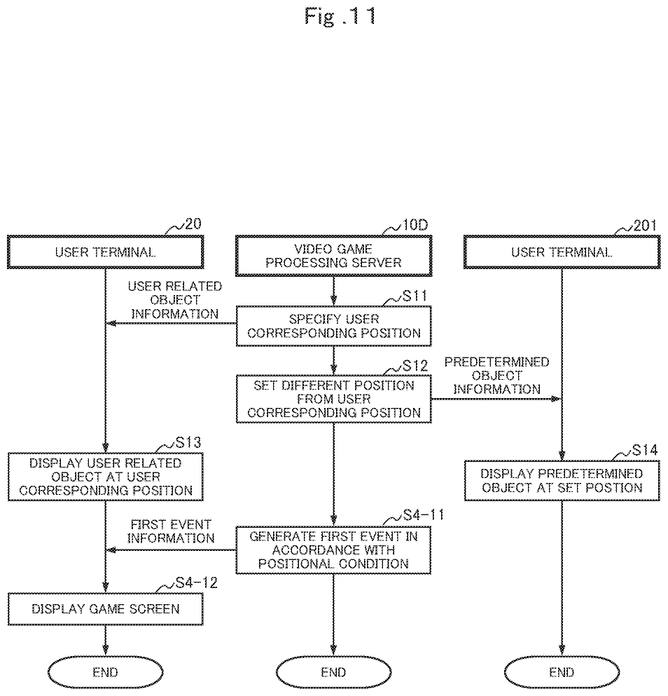

FIG. 11 is a flowchart illustrating an example of game processing executed by the system 100. Hereinafter, operations of the server 10D and the user terminal 20 (hereinafter, referred to as the “terminal 20”) will be described as an example. In this regard, a flowchart illustrating an operation of each of the server 10D and the terminal 20 is omitted from a point of view to avoid repeated explanation.

In the game processing, when a user related object is displayed at a user corresponding position for the user, the server 10D generates a first went corresponding to the user related object in accordance with a positional condition regarding a position in a virtual space corresponding to positional information of the terminal 20 of the user and the user corresponding position (Step S4-11). in the present embodiment, when the first event is generated, the server 101) transmits, to the terminal 20, first event information for displaying information regarding the first event.

When the first event information is received from the server 10D, the terminal 20 outputs a game screen to a predetermined display screen of a display device on the basis of the first event information (Step S4-12).

As explained above, as one side of the fourth embodiment, the server 10D is configured so as to include the specifying unit 11, the setting unit 12, the displaying unit 13, and the generating unit 14. Thus, the generating unit 14 generates the first event corresponding to the user related object in accordance with the positional condition regarding the position in the virtual space corresponding to the positional information of the user terminal 20 of the user and the user corresponding position. Therefore, by linking the position of the user in a real space to playing of the video game to promote the user to move in the real space, it is possible to further improve interest of the user in the video game.

### Fifth Embodiment

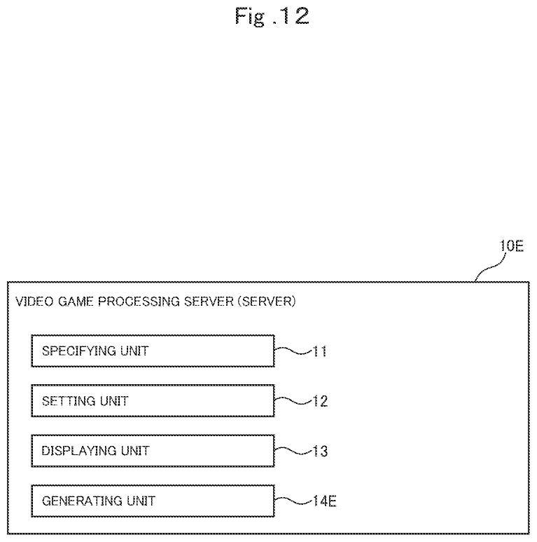

FIG. 12 is a block diagram illustrating a configuration of a video game processing server IDE (hereinafter, referred to as a “server 10E”), which is an example of the video game processing server 10 (sec FIG. 1). In the present embodiment, the server 10E at least includes a specifying unit 11, a setting unit 12, a displaying unit 13, and a generating unit 14E.

The generating unit 14E has a function to generate, as an event corresponding to a user related object, a second event to give a privilege to a user on the basis of an action of the user or a user character.

Here, the second event means an event for giving a privilege based on an action history of the user or the user character to the user. A configuration to give the privilege based on the action history of the user or the user character to the user is not limited particularly. However, it is preferable that the generating unit 14E is configured so that more privileges are given to a user as the number of actions of the user or a user character becomes larger.

Here, the action of the user means an action of the user in a real space. The action of the user in the real space is not limited particularly. However, it is preferable that a user terminal 20 is configured so as to be capable of determining the action of the user. As an example of the action of the user in the real space, there is movement of the user in the real space. In this regard, as an example of a configuration to detect movement of the user in the real space, there is a configuration to detect movement of the user in the real space on the basis of a change of positional information of the user terminal 20 due to a time course.

Further, the action of the user character means an action of the user character in a virtual space. As examples of the action in the virtual space, there are movement of a user character in the virtual space, and generation of events related to various objects in the virtual space.

Further, the privilege means something that is given to the user on the basis of the action of the user or the user character, not only may be an available clement for the user, but also may be an unavailable element. The content thereof is not limited particularly. As examples of the privilege, there arc an in-game element, and generation of a temporary process in a video game (for example, generation of so-called buffing, or a duration of an effect of an item). As examples of the available clement, there are equipment, an item, and an in-game passage. As an example of the unavailable element, there is an experience value that is associated with the user or the user related object.

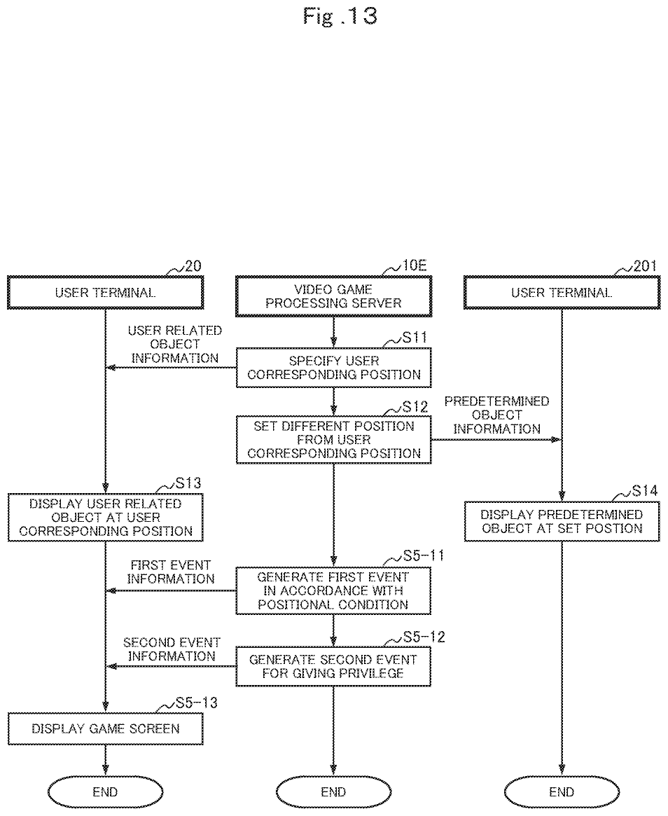

FIG. 13 is a flowchart illustrating an example of game processing executed by a video game processing system 100. Hereinafter, operations of the server 10B, the user terminal 20 (hereinafter, referred to as the “terminal 20”), and a user terminal 201 (hereinafter, referred to as a “terminal 201”) will be described as an example. In this regard, a flowchart illustrating some operations of each of the server 10B, the terminal 20. and the terminal 201 is omitted from a point of view to avoid repeated explanation.

When a user related object is displayed at a user corresponding position, the server 10E generates, as an event corresponding to the user related object, a second event that a privilege is given to the user on the basis of an action of the user or the user character (Step S5-12). In the present embodiment, when the second event is generated, the server 10E transmits, to the terminal 20, second event information for displaying information regarding the second event.

When the second event information is received from the server 10E, the terminal 20 outputs a predetermined game screen to a display screen of a display device on the basis of first event information and the second event information (Step S5-13). In this regard, in the present embodiment, the server 10E outputs the game screen at timing when the first event information and the second event in formation are received. However, the server 10E may output a game screen at timing when the first event information is received, and may output another game screen again at timing when the second event information is received.

As explained above, as one side of the fifth embodiment, the server 10E is configured so as to include the specifying unit 11, the setting unit 12, the displaying unit 13, and the generating unit 14E. Thus, the generating unit 14E generates, as the event corresponding to the user related object, the second event that the privilege is given to the user on the basis of the action of the user or the user character. Therefore, it is possible to expect that the user generates an event corresponding to the user related object more positively.

### Sixth Embodiment

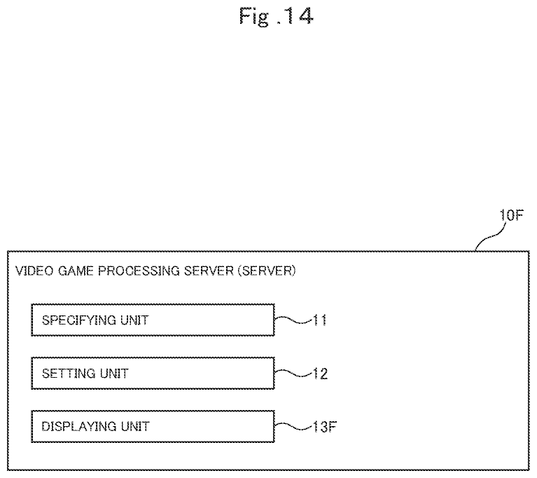

FIG. 14 is a block diagram illustrating a configuration of a video game processing server 10F (hereinafter, referred to as a “server 10F”), which is an example of the video game processing server 10 (see FIG. 1). In the present embodiment, the server 10F at least includes a specifying unit 11, a setting unit 12, and a displaying unit 13F.

The displaying unit 13F has a function to display a predetermined object at a user corresponding position for a special user who satisfies a special condition of the other users.

Here, the special condition means a condition that a user becomes the other user as a target that can display a predetermined object at a user corresponding position. The special condition is not limited particularly. However, it is preferable that the special condition is a condition that the user can define. As examples of the special condition, there are a condition that friend registration for a user is made, and a condition that the friend registration for the user is made and the user designates the condition separately.

Further, a configuration to display the predetermined object at the user corresponding position is not limited particularly. However, it is preferable that the displaying unit 13F is configured so as not to display a predetermined object at a set position for the special user, but to display the predetermined object at the user corresponding position instead.

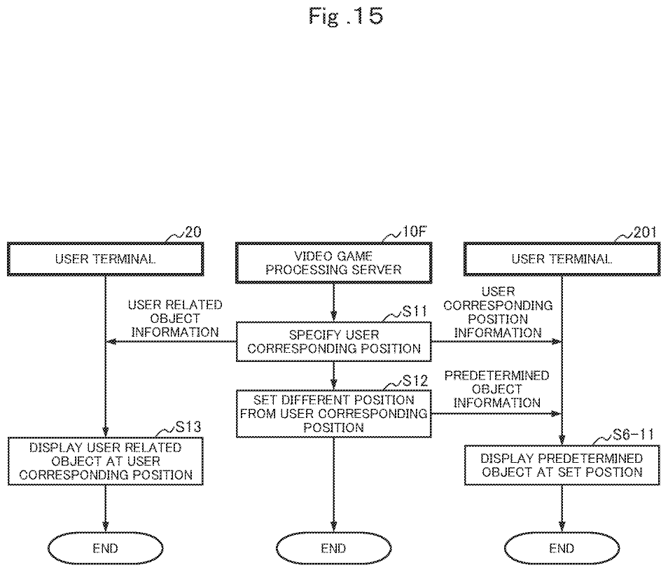

FIG. 15 is a flowchart illustrating an example of game processing executed by a video game processing system 100. Hereinafter, operations of the server 10F, a user terminal 20 (hereinafter, referred to as a “terminal 20”), and a user terminal 201 (hereinafter, referred to as a “terminal 201”) will be described as an example. In this regard, an operation of each of the server 10F, the terminal 20, and the terminal 201 is omitted from a point of view to avoid repeated explanation.

In the present embodiment, when a user corresponding position is specified, the server 10F transmits user corresponding positional information indicating the user corresponding position to the terminal 201 of a special user. In the game processing, when the user corresponding positional information and predetermined object information are received, the terminal 201 displays a predetermined object at the user corresponding position (Step S6-11).

As explained above, as one side of the sixth embodiment, the server 10F is configured so as to include the specifying unit 11, the setting unit 12, and the displaying unit 13F. Thus, the displaying unit 13F displays the predetermined object at the user corresponding position for the special user who satisfies the special condition of the other users, and displays the predetermined object at the user corresponding position for some users of the other users whom the user recognizes that there is no problem even though the predetermined object is displayed at the user corresponding position. Therefore, it becomes possible for the user to play a video game that is further linked to positional information of the terminal 20.

### Seventh Embodiment

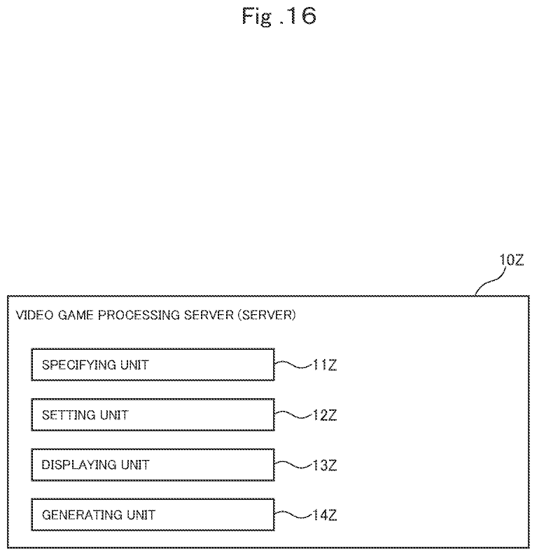

FIG. 16 is a block diagram illustrating a configuration of a video game processing server 10Z (hereinafter, referred to as a “server 10Z”), which is an example of the video game processing server 10 in the video game processing system 100 (see FIG. 1). In the present embodiment, the server 10Z at least includes a specifying unit 11Z, a setting unit 12Z, a displaying unit 13Z, and a generating unit 14Z.

The specifying unit 11Z has a function to specify a position corresponding to a user (hereinafter, referred to as a “user corresponding position”) in a virtual space corresponding to map information of a real space.

Here, the virtual space corresponding to the map information of the real space means a virtual space that is generated by using the map information of the real space. A configuration to generate the virtual space is not limited particularly. However, it is preferable that the specifying unit 11Z is configured so that the user can recognize that the virtual space is generated on the basis of the map information of the real space. Hereinafter, a configuration to generate a virtual space by respectively arranging objects corresponding lo roads and buildings of the real space at positions corresponding to the real space will be described as an example.

Further, a configuration to specify the position corresponding to the user is not limited particularly. However, it is preferable that the specifying unit 11Z is configured so that the user can recognize that the specified position corresponds to the user himself or herself. Hereinafter, a configuration to specify the position designated by the user in the virtual space as the user corresponding position will be described as an example.

Further, positional information of a user terminal 20 means information indicating a position in a real space. Hereinafter, a configuration in which positional information using a GPS signal is positional information of the user terminal 20 will be described as an example.

The setting unit 12Z has a function to set a different position from the user corresponding position in the virtual space.

Here, the phrase “set a different position from the user corresponding position” means that a coordinate different from a coordinate of the user corresponding position in the virtual space is set as a set position. Hereinafter, a configuration in which a position separated from the user corresponding position by a first distance or longer and a second distance, which is longer than the first distance, or shorter is set as the set position will be described as an example.

Here, the first distance is not limited particularly. However, it is preferable that the setting unit 12Z is configured so that it may be difficult for another user to guess the user corresponding position on the basis of the set position separated from the user corresponding position by the first distance or longer. Further, the second distance is not limited particularly. However, it is preferable that the setting unit 12Z is configured so that the set position separated from the user corresponding position by the second distance or shorter may be related to the user corresponding position. Further, as an example of the first distance or longer and the second distance or shorter, there is “1 km or longer and 3 km or shorter”.

Further, the position set by the setting unit 12Z as the set position is not limited particularly so long as it is a position separated from the user corresponding position by the first distance or longer and the second distance or shorter. Hereinafter, a configuration to select any position within an area that satisfies a condition to be separated by the first distance or longer and the second distance and shorter at random to set the selected position as the set position will be described as an example.

The displaying unit 13Z has a function to display an object related to the user (hereinafter, referred to as a “user related object”) in the virtual space.

Here, the term “object related to the user” means an object that the user or another user can recognize to be related to the user. Hereinafter, a configuration in which the object related to the user is an object indicating a base in the virtual space corresponding to the user (for example, user's home) will be described as an example.

Here, a home object corresponding to the user means an object that generates various kinds of events related to the user in the virtual space. The event related to the user is not limited particularly. However, it is preferable that the content of a process to be generated is at least related to the user. Hereinafter, a configuration in which the event related to the user is recovery of physical strength of a user character, giving of an experience value corresponding to the user's home, or browsing of the exterior or interior of the home will be described as an example.

Further, the displaying unit 13Z has a function to display the user related object at the user corresponding position for the user, and a function to display a predetermined object at a position set by the setting unit 12 (that is. the set position) for the other users.

Here, a configuration to display the user related object at the user corresponding position is not limited particularly. However, it is preferable that the user can recognize that the user related object exists at the user corresponding position in the virtual space. Hereinafter, a configuration in which the user's home is displayed at a position designated by the user in the virtual space will be described as an example.

Further, the other user means a user different from one user who uses the user terminal 20. Hereinafter, a configuration in which the other user uses another user terminal 20 different from the user terminal 20 of the user will be described as an example.

Further, the predetermined object means an object corresponding to the user related object. Hereinafter, a configuration in which the predetermined object is an object corresponding to a home object of the user (hereinafter, referred to as a “home corresponding object”) will be described as an example. In this regard, in the present embodiment, the home corresponding object is displayed on a game screen of the user terminal 20 of the other user so that the other user can recognize that the home corresponding object corresponds to the home object.

Here, the home corresponding object means an object that the other user can recognize to be the user's home in a case where the other user carries out a predetermined operation against the object. A configuration of the home corresponding object is not limited particularly. However, it is preferable that the home corresponding object is an object whose appearance is different from that of the home object. As examples of the home corresponding object, there arc an object with simpler appearance than the appearance of the home object, and an icon indicating the user's home. Further, the displaying unit 13Z may be configured so that in a case where the number of home corresponding objects displayed on the game screen is a predetermined number or more, appearance of each of the home corresponding objects becomes simplified. By configuring the displaying unit 13Z in this manner, it is possible to reduce a processing load for displaying the home corresponding objects.

Further, a configuration to display the predetermined object at the set position is not limited particularly. However, it is preferable that the displaying unit 13Z is configured so that the user can recognize that the predetermined object exists at the set position in the virtual space.

The generating unit 14Z has a function to generate a first event corresponding to the user related object in accordance with a positional condition between a position in the virtual space corresponding to positional information of the user terminal 20 of the user (hereinafter, referred to as a “virtual user position”) and the user corresponding position.

Here, the positional condition between the virtual user position and the user corresponding position means at least one predetermined condition including a condition that the virtual user position and the user corresponding position have a predetermined relationship. Hereinafter, a configuration in which the positional condition is a condition that a distance between the virtual user position and the user corresponding position is a predetermined distance or shorter and the condition is satisfied in a case where the user carries out a selecting operation against his or her home object will be described as an example.

Further, the first event corresponding to the user related object means art event that is associated with the user related object in advance. Hereinafter, a configuration in which the first event is an event related to the user or the user's home such as recovery of the physical strength of the user character, giving of the experience value corresponding to the user's home, or browsing of the interior of the user's home will be described as an example.

Further, the generating unit 14Z has a Junction to generate, as an event corresponding to the user related object, a second event in which a privilege is given to the user on the basis of an action of the user or the user character.

Here, the action of the user means an action of the user in the real space. The action of the user in the real space is not limited particularly. However, it is preferable that the generating unit 14Z is configured so that an action of the user can be determined by the user terminal 20. As an example of the action of the user in the real space, there is movement of the user in the real space. In this regard, as an example of a configuration to detect movement of the user in the real space, there is a configuration in which the movement is detected on the basis of a change in the positional information of the user terminal 20 due to a time course.

Further, the action of the user character means an action of the user character in the virtual space. Hereinafter, a configuration in which the action of the user character is a selecting operation against an object by which an in-game element giving event or a user character recovering event is generated, or movement of the user character in the virtual space will be described as an example.

Further, the privilege means something that is given to the user on the basis of the action of the user or the user character. Hereinafter, a configuration in which a privilege is an experience value corresponding to the user's home will be described as an example.

In this regard, the first event and the second event are not limited particularly. However, the first event and the second event may be con figured so as to be the same event. Namely, the generating unit 14Z may be configured so as to generate the second event in accordance with the positional condition between the virtual user position and the user corresponding position.

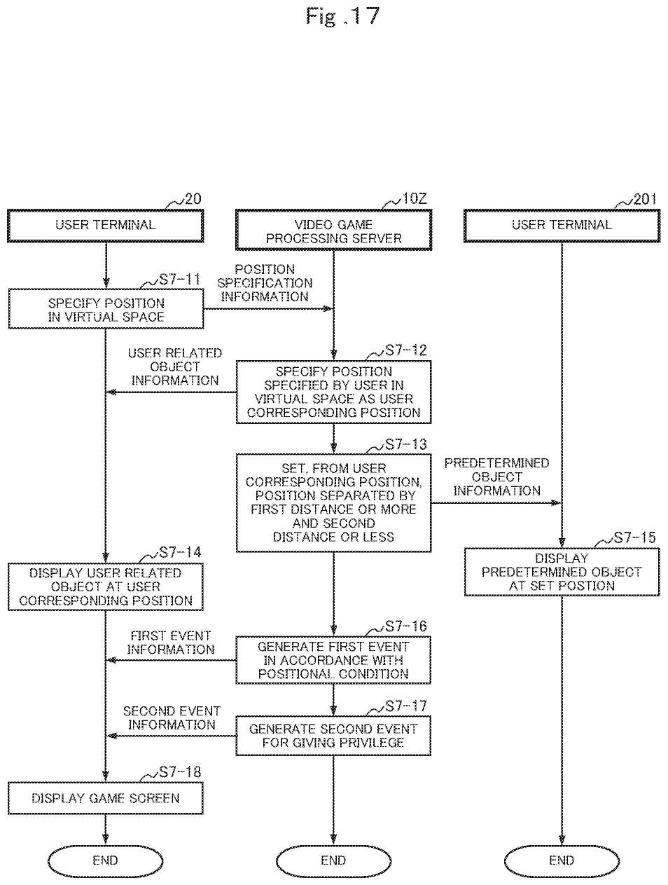

FIG. 17 is a flowchart illustrating an example of game processing executed by a video game processing system 100Z (hereinafter, referred to as a “system 100Z”) provided with the server 10Z. In the game processing according to the present embodiment, in the game processing according to the present embodiment, processes related to a control of progress of a video game in response to an operation of the user are executed. Hereinafter, each of the processes will be described. In this regard, the order of the respective processes may be changed without any contradiction or the like of processing content.

In the game processing according to the present embodiment, processes related to a control of progress of the video game by using positional information of tire user terminal 20 in response to an operation of the user is executed. Hereinafter, a case where the server 10Z, the user terminal 20 (hereinafter, referred to as a “terminal 20”), and a user terminal 201 (hereinafter, referred to as a “terminal 201”) operated by another user different front a user who operates the terminal 20 execute the game processing will be described as an example.

The game processing is started as an opportunity to receive a display request of a user related object by the terminal 20 that accesses the server 10Z, for example. Hereinafter, display of the user related object of the user who operates the terminal 20 will be described as an example.

In the game processing, the terminal 20 first designates a position in a virtual space corresponding to map information of a real space on the basis of an operation of the user (Step S7-11). in the present embodiment, the terminal 20 designates a position of a home object on the basis of the operation of the user, and transmits designated positional information indicating the designated position to the server 10Z.

When the designated positional information is received from the terminal 20, the server 10Z specifies a position designated by the user in the virtual space as a user corresponding position (Step S7-12). In the present embodiment, when the user corresponding position is specified, the server 10Z transmits, to the terminal 20, user related object information for displaying the home object of the user, which is a user related object, at the user corresponding position.

When the user corresponding position is specified, the server 10Z sets, as a set position, a position separated from the user corresponding position by a first distance or longer and a second distance or shorter (Step S7-13). In the present embodiment, when the position separated from the user corresponding position by the first distance or longer and the second distance or shorter is set as the set position, the server 10Z transmits, to the terminal 201, predetermined object information for displaying a home corresponding object of the user at the set position.

When the user related object information is received from the server 10Z, the terminal 20 displays the user related object at the user corresponding position tor the user (Step S7-14). In the present embodiment, the terminal 20 displays the home object of the user at a position designated by the user in the virtual space on the basis of the user related object information from the server 10Z.

When the predetermined object information is received from the server 10Z, the terminal 201 displays a predetermined object at the set position set by the server 10Z for the other user (Step S7-15). In the present embodiment, the terminal 201 displays the home corresponding object of the user at the set position on the basis of the user related object information from the server 10Z.

In the game processing, when the user related object is displayed at the user corresponding position for the user, the server 10Z generates a first event corresponding to the user related object in accordance with a positional condition between a virtual user position and the user corresponding position (Step S7-16). In the present embodiment, in a case where a distance between the virtual user position and the user corresponding position is a predetermined distance or shorter and the user carries out a selecting operation against the home object of the user, the positional condition is satisfied, an event related to the user or the home object of the user is generated. Further, in the present embodiment, when the first event is generated, the server 10Z transmits, to the terminal 20, first event information for displaying information regarding the first event.

In the game processing, when the user related object is displayed at the user corresponding position for the user, the server 10Z generates, as an event corresponding to the user related object, a second event in which a privilege is given to the user on the basis of an action of the user or a user character (Step S7-17). In the present embodiment, an experience value corresponding to the user's home is given to the user as the privilege on the basis of the action of the user or the user character. In the present embodiment, when the second event is generated, the server 10Z transmits, to the terminal 20, second event information for displaying information regarding the second event.

When the second event information is received from the server 10Z, the terminal 20 outputs a predetermined game screen to a display screen of a display device on the basis of the first event information and the second event information (Step S7-18).

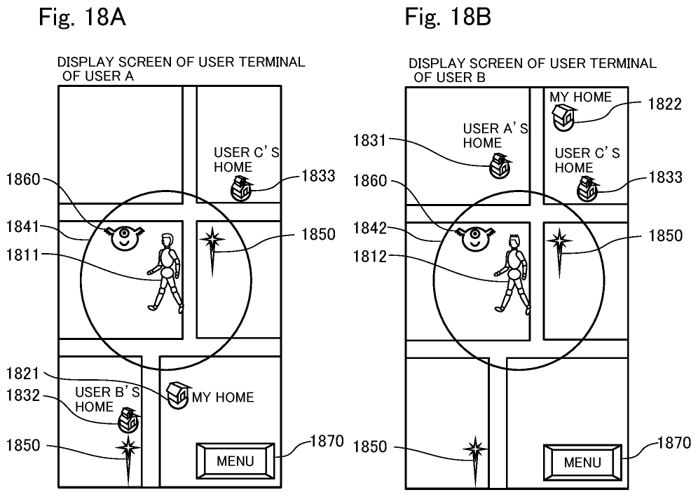

FIGS. 18A and 18B are explanatory drawings illustrating an example of the game screen. FIG. 18A illustrates a display screen of a user terminal 20 of a user A, and FIG. 18B illustrates a display screen of a user terminal 20 of a user R. Here, the user B is the other user for the user A, and the user A is the other user for the user B.

A video game according to the present embodiment includes content that is called as a so-called role-playing game. A user character that is an avatar of the user searches a virtual space to discover an item, or lights against a monster, whereby growth of the user character or progress of a story in the video game occurs. Further, the user interacts with the other users via a home object or the like.

The game screen illustrated in FIG. 8A will first be described. A user character 1811 of the user A is illustrated on the game screen, and an event generatable area 1841 is provided around the user character 1811. Further, a home object 1821 of the user A, a home corresponding object 1832 of the user B, a home corresponding object 1833 of a user C, a recovery spot 1850, and a monster object 1860 are illustrated on the game screen. Here, each of the home corresponding object 1832 of the user B and the home corresponding object 1833 of the user C has appearance different from that of the home object 1821 of the user A. In this regard, in the present embodiment, to which user the object is related is displayed for each of the home corresponding object 1832 of the user B and the home corresponding object 1833 of the user C. However, such a mark may of course be configured so as not to be displayed, or may be configured so as to be displayed by carrying out a predetermined additional operation.

The user character 1811 is illustrated in substantially the center of the display screen, and is displayed at a position in the virtual space that corresponds to positional information of the terminal 20. Namely, when a position of the terminal 20 in a real space changes, the user character 1811 also moves in the virtual space in the similar manner. Further, the event generatable area 1841 also moves in accordance with movement of the user character 1811.

The event generatable area 1841 indicates an area that satisfies a condition to generate an event of an object regarding a positional relationship between the position of the user character 1811 and the object. As illustrated in FIG. 18A, the recovery spot 1850 and the monster object 1860 positioned within the event generatable area 1841 satisfy the condition described above. Each event of the recovery spot 1850 and the monster object 1860 may be generated in a state where the condition described above is satisfied by execution of a selecting operation of the user, or may be generated automatically.

An event to recover physical strength of the user character 1811 or give a predetermined item to the user is generated at the recovery spot 1850. A battle event against a monster corresponding to the monster object 1860 is generated at the monster object 1860.

In a case where the home object 1821 is positioned within the event generatable area 1841, an event related to home of the user A is generated in accordance with a selecting operation of the user against the home object 1821. Further, in a case where the objects 1832 and 1833 corresponding to the other users' homes are positioned within the event generatable area 1841, an event related to each of the homes of the users B and C is generated in accordance with a selecting operation from the user against the home object 1821.

An event such as recovery of the physical strength of the user character 1811, remodeling of the home, or an increase in a rank corresponding to the home is generated at the home object 1821. In this regard, the rank corresponding to the home increases on the basis of an action of the user or the user character. When the rank corresponding to the home increases, a privilege such as furniture that can be installed in the home is given to the user, or an event in which the home becomes larger is further generated.

Events related to the users 8 and C or events related to the homes of the users B and C are respectively generated at the home corresponding objects 1832 and 1833 of the other users. As examples of the event to be generated, there are browsing of the exterior or interior of the home, status confirmation of each user, and a friend request. Further, when the user carries out a selecting operation against a menu button 1870, a setting screen regarding tire video game is displayed. As an example of an item that can be set through the setting screen regarding the video game according to the present embodiment, there is an item of a method of disclosing the user's home in the virtual space to the other users. As examples of the method of disclosing the user's home to the other users, there arc a method of disclosing a position of the user's home as it is, a method of disclosing the position of the user's home by being shifted by a predetermined distance, and a method of not disclosing it to the other users.

Next, the game screen illustrated in FIG. 18B will be described. A user character 1812 of the user B is illustrated on the game screen. Here, although the times are different from each other, a position of the user character 5812 is substantially the same position of the user character 1811 illustrated in FIG. 18A. Further, an object 1831 corresponding to the home of the user A is illustrated in FIG. 18B. The object 1831 corresponding to the home of the user A is a position separated from the home object 1821 illustrated in FIG. 18A by a distance that is equal to or longer than a first distance and is equal to or shorter than a second distance. An example of the distance that is equal to or longer than a first distance or longer and is equal to or shorter than a second distance or shorter is “1 km to 3 km” (a distance between 1 km and 3 km). On the other hand, a home object 1822 of the user B is illustrated in FIG. 18B. The position of the object 1832. corresponding to the home of the user B illustrated in FIG. 18A is a position separated from the home object 1822 of the user B illustrated in FIG. 18B by the first distance or longer and the second distance or shorter.

As explained above, as one side of the seventh embodiment, the server 10Z is configured so as to include the specifying unit 11Z, the setting unit 12Z, and the displaying unit 13Z. Thus, the specifying unit 11Z specifies the position corresponding to the user (the user corresponding position) in the virtual space corresponding to the map information of the real space; the setting unit 12Z sets the different position from the user corresponding position in the virtual space; and the displaying unit 13Z displays the user related object at the user corresponding position (for example, the position designated by the user as the user's home) for the user, and displays the predetermined object at the position set by the setting unit 12 (that is, the set position; for example, a position obtained by shifting the user's home by a method selected by the user as a method of disclosing the user's home to the other users) for the other users. Therefore, it is possible to allow the user to play the video game with security.

In this regard, it has not been mentioned particularly in the seventh embodiment described above. However, the server 10Z may be configured so as to include a receiving unit for receiving any selection of a plurality of setting methods defined in advance from the user, and set a position defined by the setting method received by the receiving unit as a set position. By configuring the server 10Z in this manner, it is possible for the user to select a degree of how to disclose the positional information of the user. Therefore, it is possible to keep a balance between maintenance of interest of the user in the video game using the positional information and privacy protection, and this makes it possible for the user to play the video game with security.

Further, it has not been mentioned particularly in the seventh embodiment described above. However, a configuration to: at random select any position within an area that satisfies a condition separated by a first distance or longer and a second distance or shorter; and set the selected position as a set position may be a configuration to set the position to substantially the same position as the set position corresponding to the other user, or may be a configuration to set the position to a position different from the set position corresponding to the other user. Here, it is preferable that in a case where the position is set to substantially the same position as the set position corresponding to the other user, a predetermined single object is displayed at a set position corresponding to a plurality of other users. As an example of a configuration to display the predetermined single object, there is an example in which a predetermined object represented from predetermined objects corresponding to a plurality of other users is displayed, and information for promoting a user to select any predetermined object is displayed in accordance with an operation from the user against the predetermined object. By configuring the server 10Z in this manner, it is possible to reduce a processing load on display of a predetermined object. Further, it is possible to reduce an error of a selecting operation in a case where the user selects any of a plurality of predetermined objects in the virtual space. Moreover, it is preferable that the server 10Z is configured so that in a case where the position is set to a position different from the set position corresponding to the other user, a plurality of predetermined objects is displayed so as to be separated from each other by a predetermined distance or longer. As an example of the configuration to display them so as to be separated from each other by the predetermined distance, there is a configuration in which a plurality of predetermined objects is displayed by spacing a distance so that the predetermined objects do not overlap each other. By configuring the server 10Z in this manner, it is possible to prevent the predetermined objects from overlapping each other.

In this regard, the server 10Z may be configured so as to set the position to a position different from the set position corresponding to an avoidance user who satisfies an avoidance condition defined in advance from at least one of the other users in a case where any position is selected at random from an area that satisfies a condition to be separated by the first distance or longer and the second distance or shorter to set the selected position as the set position. Here, the avoidance condition means another user who does not want to display a predetermined object of the user himself or herself near the user corresponding position among the other users whose user corresponding positions arc specified. Namely, the avoidance condition means another user who does not want to notify existence of the user himself or herself.

Further, it has not been mentioned particularly in the seventh embodiment described above. However, the predetermined object may not be the user related object. Namely, the user related object may be displayed at the set position for the other users. In this regard, even in a case where the predetermined object is the user related object, it may be an object whose appearance is at least different. By displaying the same object for the other users, awareness of sharing the virtual space is heightened among the users. For this reason, it is possible to improve interest of the user in the video game.

Further, it has not been mentioned particularly in the seventh embodiment described above. However, the user corresponding position may be a position regarding the personal information of the user. As an example of the position regarding the personal information of the user, there is a place in the real space, which is connected to a life of the user and which the user does not want for the other users to know, (that is, a user secret place). As examples of the user secret place, there are positions such as a user's home, a parent's or child's home of the user, a work place, an acquaintance's home, a user's school, stores where the user is a regular customer, or the nearest station from the user's home. Namely, the setting unit 12Z sets a position different from a position of personal information of the user specified by the specifying unit 11Z as the user corresponding position as the set position. For this reason, it is possible to protect only information that is to be protected actually. Therefore, it is possible to cause the user himself or herself to play the video game with security while disclosing the position corresponding to the user without making the user excessively aware of a privacy protecting method.

Further, it has not been mentioned particularly in the seventh embodiment described above. However, the server 10Z may be configured so as to specify a position in the virtual space corresponding to the positional information of the terminal 20 of the user (that is, the virtual user position) as the user corresponding position. Here, as an example of the user related object displayed by the displaying unit 13Z, there is a user character. Here, the displaying unit 13Z displays the predetermined object corresponding to the user character for the other users. The predetermined object corresponding to the user character is not limited particularly. However, it is preferable that the displaying unit 13Z may be configured so that the other user can recognize that a character similar to the user character is displayed at the user corresponding position. In this regard, the server 10Z may be configured so that in a case where the user corresponding position is the virtual user position, a current virtual user position is specified as the user corresponding position in accordance with a change in the virtual user position due to movement of the user in the real space. Here, the phrase “in accordance with a change in the virtual user position due to movement of the user in the real space” means that a current virtual user position is specified as the user corresponding position in a case where it is determined that a change in the virtual user position is a predetermined distance or longer. As examples of a configuration to determine that the change in the virtual user position is the predetermined distance or longer, there are a configuration in which the terminal 20 detects that the virtual user position changes by the predetermined distance or longer and notifies the server 10Z of the change in the virtual user position, and a configuration in which the server 10Z causes the terminal 20 to transmit the virtual user position at predetermined time intervals. By configuring the server 10Z in this manner, it is possible to feel existence of the other user in the same virtual space, and this makes it possible to expect that a plurality of users will have a sense of unity.

Further, the server 10Z may be configured so that in a case where the server 10Z specifies the virtual user position as the user corresponding position, the server 10Z sets, on the basis of information indicating an area that cannot be set as the set position in the virtual space (that is, a non-settable area), a position different from both the user corresponding position and a position within the non-settable area as the set position. Here, area that cannot be set as the set position in the virtual space means an area where it is difficult for the user to be located in the real space. As examples of the area where it is difficult for the user to be located, there are areas that cannot be invaded on foot in the real space such as rivers and the sea, mountains where people are not supposed to enter, and areas determined that invasion is prohibited. A configuration to set the different position from the position within the non-settable area as the set position is not limited particularly. However, in a ease where positions within the non-settable area are defined by a rule for determining the set position from the user corresponding position, the set position may be set outside the non-settable area. A configuration to set the set position outside the non-settable area is not limited particularly. However, it is preferable that the set position is a position in the vicinity of the outside of the non-settable area. By configuring the server 10Z in this manner, it is possible to prevent the other users from feeling uncomfortable with the virtual space by displaying the user character at a position in the virtual space corresponding to a position where the user should not be located in the real space.

Further, the server 10Z may be configured so as to display a predetermined object at a user corresponding position even for the other users in a case where the server 10Z specifies a position within a predetermined area in the virtual space corresponding to the positional information of the terminal 20 of the user as the user corresponding position. The predetermined area is not limited particularly. However, it is preferable that the predetermined area is an area where a larger number of users exist compared with the surrounding area. As examples of the predetermined, there are an area in an event venue regarding the present video game, an area in an event venue that directly has no relationship with the present video game, and an area in predetermined facility. By configuring the server 10Z in this manner, it is possible to recognize that users are actually gathered in the predetermined area. For this reason, it is possible to expect that a plurality of users will have a sense of unity compared with a case where the predetermined object is displayed at the set position.

Further, the server 10Z may be configured so as to display a predetermined object before a predetermined time for the other use is in a case where the virtual user position is specified as the user corresponding position. Here, the phrase “display a predetermined object before a predetermined time” means that the predetermined object is displayed at a position that is set as the set position before the predetermined time from the present. A configuration to display the predetermined object before the predetermined time is not limited particularly. However, it is preferable that the server 10Z may be configured so as To display the predetermined object at a position where it is difficult to guess the position of the user in the real space. As an example of the configuration to display the predetermined object before the predetermined time, there is a configuration in which the predetermined object is displayed at a predetermined position in a case where the user corresponding position changes from the predetermined position by a predetermined distance or longer and a predetermined time then elapses. By configuring the server 10Z in this manner, it is possible to make it difficult to guess a current position of the user.

As explained above, one or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, and 201 to 20N and the server 10 executes the various kinds of processing described above in accordance with various kinds of control programs (for example, a video game processing program) stored in the storage device with which the corresponding terminal or server is provided.

Further, the configuration of the system 100 is not limited to the configuration that has been explained as an example of each of the embodiments described above. For example, the system 100 may be configured so that the server 10 executes a part or ail of the processes that have been explained as the processes executed by the user terminal 20. Alternatively, the system 100 may be configured so that any of the plurality of user terminals 20, and 201 to 20N (for example, the user terminal 20) executes a part or all of the processes that have been explained as the processes executed by the server 10. Further, the system 100 may be configured so that a pan or all of the storage unit included in the server 10 is included in any of the plurality of user terminals 20, and 201 to 20N. Namely, the system 100 may be configured so that a part or all of the functions of any one of the user terminal 20 and the server 10 according to the system 100 is included in the other.

Further, the system 100 may be configured so that, the program causes a single apparatus to perform a part or all of the functions that have been explained as the example of each of the embodiments described above without including a communication network.

(Appendix)

The explanation of the embodiments described above has been described so that the following embodiments can be at least performed by a person having a normal skill in the an to which the present disclosure belongs.

(1)

A non-transitory computer-readable medium including a video game processing program tor causing a server to perform functions to control progress of a video game using positional information of a user terminal in response to an operation of a user, the functions comprising:

a specifying function configure to specify a position of the user (hereinafter, referred to as a “user corresponding position”) in a virtual space corresponding to snap information of a real space;

a setting function configured to set a different position from the user corresponding position in the virtual space; and

a displaying function configured to display an object related to the user (hereinafter, referred to as a “user related object”) in the virtual space,

wherein the displaying function includes:

a function configured to display the user related object at the user corresponding position for the user; and

a function configured to display a predetermined object at a position set by the setting function (hereinafter, referred to as a “set position”) for the other users.

(2)

The non-transitory computer-readable medium according to (1),

wherein the specifying function includes a function configured to specify a position designated by the user in the virtual space as the user corresponding position.

(3)

The non-transitory computer-readable medium according to (1) or (2),

wherein the setting function includes a function configured to set, as the set position, a position separated from the user corresponding position by a first distance or longer and a second distance or shorter, the second distance being longer than the first distance.

(4)

The non-transitory computer-readable medium according to any one of (1) to (3), the functions further comprising:

a generating function configured to generate a first event in accordance with a position in the virtual space corresponding to positional information on the user terminal of the user and a positional condition regarding the user corresponding position, the first event corresponding to the user related object.

(5)

The non-transitory computer-readable medium according to (4),

wherein the generating function includes a function configured to generate a second event as an event corresponding to the user related object, a privilege being given to the user on a basis of an action of the user or a user character in the second event.

(6)

The non-transitory computer-readable medium according to any one of (1) to (5),

wherein the displaying function includes a function configured to display the predetermined object at the user corresponding position for a special user who satisfies a special condition of the other users.

(7)

The non-transitory computer-readable medium according to any one of (1) to (6), the functions further comprising:

a receiving function configured to receive any one selection of a plurality of setting methods defined in advance from the user, and

wherein the setting function includes a function configured to set, as the set position, a position defined by the setting method received by the receiving function.

(8)

The non-transitory computer-readable medium according to any one of (1) to (7),

wherein the predetermined object is- a user related object.

(9)

The non-transitory computer-readable medium according to any one of (1) to (8),

wherein the user corresponding position is a position regarding personal information of the user.

(10)

A non-transitory computer-readable medium including a video game processing program for causing a user terminal to perform at least one function of the functions that the video game processing program described in any one of (1) to (9) causes the server to perform, the user terminal being capable of communicating with the server.

(11)

A server into which the video game processing program described in any one of (1) to (10) is installed.

(12)

A video game processing system for controlling progress of a video game using positional information of a user terminal in response to an operation of a user, the video game processing system comprising a communication network, a server, and a user terminal, the video game processing system further comprising:

a specifying unit configured to specify a position of the user (hereinafter, referred to as a “user corresponding position”) in a virtual space corresponding to map information of a real space;

a setting unit configured to set a different position from the user corresponding position in the virtual space: and

a displaying unit configured to display an object related to the user (hereinafter, referred to as a “user related object”) in the virtual space,

wherein the displaying unit is configured to:

display the user related object at the user corresponding position for the user; and

display a predetermined object at a position set by the setting unit (hereinafter, referred to as a “set position”) for the other users.

(13)

The video game processing system according to (12),

wherein the server includes the specifying unit, the setting unit, and the displaying unit, and

wherein the user terminal includes an outputting unit configured to output a game screen to a display screen of a display device, the game screen indicating a state where the user related object and the predetermined object are displayed by the displaying unit.

(14)

A non-transitory computer-readable medium including a video game processing program for causing a user terminal to perform terminal functions, the terminal functions comprising:

a function configured to receive, from a server, information regarding server functions included in the server; and

a function configured to execute an input or an output corresponding to each of the server functions,

wherein the server performs the server f unctions to control progress of a video game using positional information of the user terminal in response to an operation of a user, the server functions comprising:

a specifying function configure to specify a position of the user (hereinafter, referred to as a “user corresponding position”) in a virtual space corresponding to map information of a real pace;

a setting function configured to set a different position from the user corresponding position in the virtual space; and

a displaying function configured to display an object related to the user (hereinafter, referred to as a “user related object”) in the virtual space, and

wherein the displaying function includes:

a function configured to display the user related object at the user corresponding position for the user; and

a function configured to display a predetermined object at a position set by the setting function (hereinafter, referred to as a “set position”) for the other users.

(15)

A video game processing method of controlling progress of a video game using positional information of a user terminal in response to an operation of a user, the video game processing method comprising:

a specifying process configured to specify a position of the user (hereinafter, referred to as a “user corresponding position”) in a virtual space corresponding to map information of a real space;

a setting process configured to set a different position from the user corresponding position in the virtual space; and

a displaying process configured to display an object related to the user (hereinafter, referred to as a “user related object”) in the virtual space,

wherein the displaying process includes:

a process configured to display the user related object at the user corresponding position tor the user; and

a process configured to display a predetermined object at a position set by the setting function (hereinafter, referred to as a “set position”) for the other users.

(16)

A video game processing method of controlling progress of a video game using positional information of a user terminal in response to an operation of a user by a video game processing system, the video game processing system including a communication network, a server, and a user terminal, the video game processing method comprising:

a specifying process configured to specify a position of the user (hereinafter, referred to as a “user corresponding position”) in a virtual space corresponding to map information of a real space;

a setting process configured to set a different position from the user corresponding position in the virtual space; and

a displaying process configured to display an object related to the user (hereinafter, referred to as a “user related object”) in the virtual space,

wherein the displaying process includes:

a process configured to display the user related object at the user corresponding position for the user; and

a process configured to display a predetermined object at a position set by the setting function (hereinafter, referred to as a “set position”) for the other users.

### INDUSTRIAL APPLICABILITY

According to one of the embodiments of the present disclosure, it is useful to allow a user to play a video game with security.

What is claimed is:

1. A non-transitory computer-readable medium including a video game processing program for causing a server to perform functions to control progress of a video game using positional information of a user terminal in response to an operation of a user, the functions comprising:
specifying a user corresponding position that is a position of the user in a virtual space corresponding to map information of a real space;
setting a set position different from the user corresponding position in the virtual space; and
causing to display a user related object that is an object related to the user in the virtual space at the user corresponding position to the user; and
causing to display a predetermined object at the set position in the virtual space to other users.

2. The non-transitory computer-readable medium according to claim 1, the functions further comprising:
specifying a position designated by the user in the virtual space as the user corresponding position.

3. The non-transitory computer-readable medium according to claim 1, the functions further comprising:
setting the set position, separated from the user corresponding position by a distance that is equal to or longer than a first distance or longer and is equal to or shorter than a second distance.

4. The non-transitory computer-readable medium according to claim 1, the functions further comprising:
generating a first event corresponding to the user related object in accordance with a positional condition between the user corresponding position and a position in the virtual space corresponding to positional information on the user terminal of the user.

5. The non-transitory computer-readable medium according to claim 4, the functions further comprising:
generating a second event corresponding to the user related object, the second event configured to give a privilege to the user on a basis of an action of the user or a user character in the second event.

6. The non-transitory computer-readable medium according to claim 1, the functions further comprising:
causing to display the predetermined object at the user corresponding position to a special user who satisfies a special condition among the other users.

7. The non-transitory computer-readable medium according to claim 1, the functions further comprising:
receiving a setting method selected by the user among a predefined plurality of setting methods; and
setting a position defined by the received setting method as the set position.

8. The non-transitory computer-readable medium according to claim 1, wherein the predetermined object is a user related object.

9. The non-transitory computer-readable medium according to claim 1,
wherein the user corresponding position is a position regarding personal information of the user.

10. A video game processing system for controlling progress of a video game using positional information of a user terminal in response to an operation of a user, the video game processing system comprising:
a communication network:
a user terminal; and
one or more processors configured to specify a user corresponding position that is a position of the user in a virtual space corresponding to map information of a real space, to set a set position different from the user corresponding position in the virtual space, and further configured to cause a user terminal of the user to display a user related object that is an object related to the user at the user corresponding position in the virtual space, and
wherein the one or more processor is further configured to cause one or more user terminals of other users to display a predetermined object at the set position.

11. The video game processing system according to claim 10, further comprising:
a server including the one or more processors,
wherein the user terminal of the user is configured to output a game screen to a display screen of a display device, the game screen indicating a state where the user related object and the predetermined object are caused to be displayed by the server.

12. A non-transitory computer-readable medium including a video game processing program for causing one or more user terminals to perform terminal functions, the terminal functions comprising:
receiving, from a server, information regarding server functions included in the server; and
inputting or outputting corresponding to each function of the server functions,
wherein the server is configured to perform the server functions to control progress of a video game using positional information of the user terminal in response to an operation of a user, the server functions comprising:
specifying a position of the user in a virtual space corresponding to map information of a real space;
setting another position different from the position of the user in the virtual space;
causing a user terminal of the user to display an object related to the user at the position of the user in the virtual space; and
causing a user terminal of another user to display a predetermined object at the other position.
